(19) United States
(12) Patent Application Publication
(10) Pub. No.: US 2016/0274233 A1
(43) Pub. Date: Sep. 22, 2016

(54) Vertical composite technique for interpolating surface-relevant Doppler radar reflectivity from in-progress NEXRAD plan position indicator (PPI) scans.

(71) Applicant: Paul Maravelias, Windham, NH (US)

(72) Inventor: Paul Maravelias, Windham, NH (US)

(73) Assignee: Maravelias Digital, LLC, Windham, NH (US)

(21) Appl. No.: 15/169,596

(22) Filed: May 31, 2016

(51) Int. Cl. G01S 13/95; G01S 7/41

(52) U.S. Cl. CPC G01S 13/951; G01S 7/414

(57) ABSTRACT

A vertical reflectivity composition method for weather radar display is disclosed. Rapid visual updates from incomplete NEXRAD Doppler radar volume scans advance the current state of the art for real-time tactical awareness purposes. Continuous groups of plan-position indicator (PPI) scan radials are composited onto a base array of constant per-radial azimuth defined by the initial scan of the volume. A novel variable-altitude plan-position indicator (VAPPI) method is employed to interpolate reflectivity echoes according to surface proximity within the VAPPI volume. Dynamic adjustments to the VAPPI vertical extremum adopt the maximum detected height of an adaptable reflectivity isosurface. Linear azimuthal resampling endeavors to correct angular disjunction between new composited radials and the composite base array. Legacy resolution one-degree-width radials are bisected to maintain original high-definition resolution of the half-degree azimuthal width composite radials. Computational efficiency optimizations are employed to achieve real-time performance on inexpensive consumer hardware.

### CROSS-REFERENCE TO RELATED APPLICATIONS

Not Applicable.

### STATEMENT REGARDING FEDERALLY SPONSORED RESEARCH OR DEVELOPMENT.

Not Applicable.

### THE NAMES OF THE PARTIES TO A JOINT RESEARCH AGREEMENT.

Not Applicable.

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC.

Not Applicable.

### STATEMENT REGARDING PRIOR DISCLOSURES BY AN INVENTOR OR JOINT INVENTOR.

Not Applicable.

### BACKGROUND OF THE INVENTION

1. Field of the invention

The present invention is directed to the field of computer graphics and in particular to the visual representation of datasets pertaining to observational meteorological sciences.

2. Description of related art.

Systems for displaying two-dimensional graphs of Doppler radar return echoes have existed in some form for over a half-century both within and outside of meteorological contexts. The plan-position indicator (PPI) radar display conceptualizes return echo intensity across two dimensions in which each return corresponds to a fixed elevation angle for all azimuths and therefore to variable ground height increasing with range from the radar. Thus, the presented image does not represent a planar surface relative to Earth's surface but rather a conical section of increasing non-linear height as the radar beam propagates into the atmosphere. In the strictly meteorological context, McGill researches devised a scheme for interpolating multiple radar scans at diverse elevation angles into a constant-elevation (relative to ground) display known as the constant-altitude plan-position indicator (CAPPD (Langleben & Gaherty, 1957).

A further premise related to the present invention concerns the “Composite Reflectivity” derived product generated by the NOAA NEXRAD weather radar RPG (“Radar Product Generator”) system, which constructs an equirectangular grid around the radar site and reprojects reflectivity returns from each plan-position indicator tilt thereunto, eschewing all echoes at a given bin but the maximum of all available tilts, thereby generating a representation of the maximum reflectivity value at any tilt elevation over each grid cell. This procedure achieves the benefit of representing areas of greater reflectivity potentially associated with higher-level convective structures that may be invisible in the base PPI scan (which is conducted at a tilt elevation of 0.5° by the WSR-88D radar), however is prone to exaggerate visually the intensity of surface-relevant precipitation levels due to 1) representing higher-altitude virga structures whence falling hydrometeors may evaporate before reaching the surface, and 2) co-representing temporally distinct regions of high reflectivity in earlier elevation scans, especially exacerbated by fast overall ground-relative motion of reflective atmospheric hydrometeoric strucutres (a common occurrence in convective thunderstorm outbreaks driven by strong upper-level winds). To the latter causal identification of positive bias inherent to the composite reflectivity product, a convective structure travelling 50mph away from the radar beam origin sampled at different heights between the 0.5° and 19.5° tilt elevations would afford roughly four whole miles of potentially repetitive reflectivity echoes, misattributed to one point in time by the composite reflectivity product, having been sampled from the motion of the same cell however at distinct times (assuming 4.5 minutes between the two aforesaid tilt scans' execution, which accords to a non-SAILS implementation of the NEXRAD WSR-88D Volume Coverage Pattern (VCP) 12), exaggerating storm width and perceived intensity.

The present invention relates to both aforementioned premises of interpolating reflectivity data from multiple PPI scans at varied tilts and of generating a composite product at each point from the array of return echoes at each elevation. Both the CAPPI display and the Composite Reflectivity product inherit the disadvantage natural to any multi-scan-based derived radar product of necessitating a complete array of vertical scans for computation, and therefore of requiring the user to await the completion of an entire “volume scan” (the summation of each scan at the specific tilt elevations), whereas the initial base PPI scan data is available long before the proceeding higher tilt scans are completed.

### BRIEF SUMMARY OF THE INVENTION.

The present invention overcomes traditional temporal and spatial limitations which heretofore afflict available meteorological radar displays by 1) deciding the optimal height of a surface-relative reflectivity composite volume, 2) composting each progressive azimuthal ray of reflectivity returns from each elevation scan according to a fuzzy logic interpolation coefficient which modulates the contribution of each reflectivity value according to surface-relative ground height (using beam elevation above radar level as a sufficient proxy for the aforesaid), and 3) employing special optimization techniques to perform the above in real-time and throughout the interstitial progress of a given NEXRAD volume scan, requiring the completion of only the base-level 0.5° scan rather than the entire volume. This allows meteorologically relevant and tactically actionable visual representations of new radar data to be presented in a single data product that 1) updates every few seconds, as opposed to every few minutes, and 2) for which temporal latency behind the real-time progress of the radar (both as an artifact of data latency in the NEXRAD Level II stream and of the present invention's processing time) may be easily reduced below ten seconds within the environment of inexpensive and readily available interne connections and consumer graphics hardware. The present invention therefore promises a substantial contribution to real-time radar-aided weather monitoring and public safety contexts in which the timeliness of visual radar data display propagates meaningful consequences for the protection of life and property.

### BRIEF DESCRIPTION OF THE SEVERAL VIEWS OF THE DRAWING.

For a further understanding of the nature and objects of the present invention, reference should be had to the following detailed description, taken in conjunction with the accompanying drawings, in which like parts are given like reference numerals, and wherein:

FIG. 1 is a flowchart depicting a generalized high-level representation of the present invention's core algorithmic execution steps; and

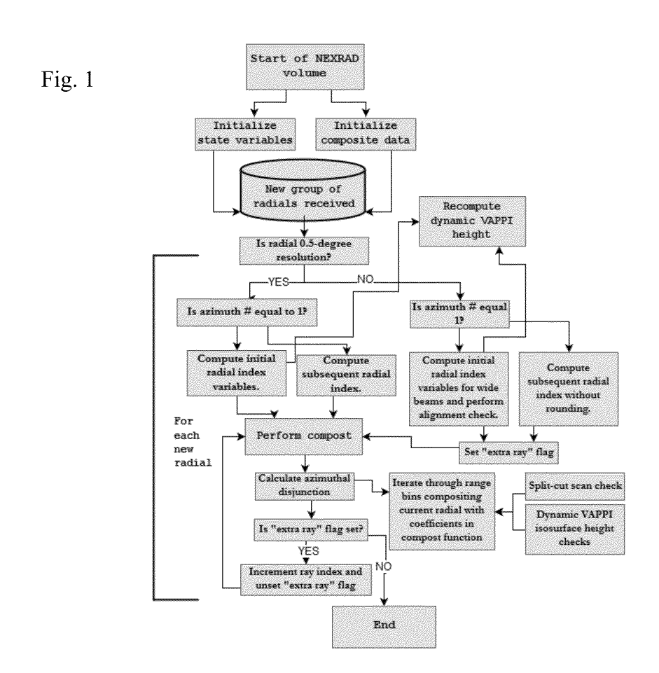

FIG. 2 depicts a cross-sectional view of the present invention's variable-altitude plan-position indicator (VAPPI) volume including altitudinal lines representing reference radial NEXRAD radar beam elevation, and including below the cross-sectional view a graph depicting the composting function coefficients which follow along the range axis from the given reference radial's vertical elevation within the VAPPI volume.

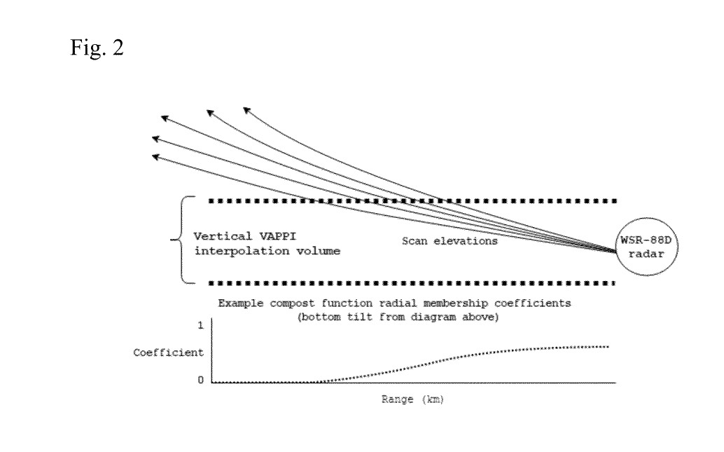

### DETAILED DESCRIPTION OF THE INVENTION

In a preferred embodiment of the present invention described in the following paragraphs, real-time efficiency techniques implement the vertical composition on modem consumer PC hardware in less than five seconds for full NOMAD volume scans and in mere deciseconds for processing successive radial chunk segments throughout the volume scan's progression. The technique described herein has been implemented in a commercial Windows NOMAD radar visualization program and typically executes the following algorithm in entirety for display in a hardware-accelerated graphical environment in less than ten seconds from the timestamp of the newest azimuthal ray of radar returns on standard residential, university, and public interne connection bandwidth speeds and with entry-level consumer computing hardware.

The present invention follows a tripartite algorithm directed towards real-time display and therefore to be executed at a user specified interval throughout the NEXRAD volume scan. The first group of steps pertains to initializing the system for a new NEXRAD volume scan and is skipped in subsequent executions of the algorithm until the next volume scan is initiated. The second group of steps pertains to high-level processing of new groups of azimuthal rays of radar reflectivity data. The third group of steps pertains to the final composting process of the aforesaid rays in a routine invoked from within the second group of steps.

The first group of algorithm steps is invoked at the onset of every new NEXRAD volume scan and establishes several key state variables and memory structures.

Step 1 establishes two floating-point state variables for defining the lower and upper vertical heights of the reflectivity interpolation range, hereinafter referred to as “VAPPIBaseHeight” and “VAPPITopHeight” and initialized to 0 and 1,000 meters respectively. The terminology “VAPPI” is elected to contrast the present invention's characteristic and novel implementation of a “variable-altitude” plan-position indicator (VAPPI) with the isoaltitude CAPPI (constant-altitude plan-position indicator). The initialization of “VAPPITopHeight” to 1,000 meters serves only robustness purposes as the algorithm detailed in following sections will dynamically recompute this state variable according to variations in the maximum height of a certain reflectivity isosurface.

As the preferred embodiment of the present invention performs the following composite algorithm on the original NEXRAD resolution radial data of 0.5° azimuthal-axis increments and of 0.25 km range-axis increments, notwithstanding that alternative embodiments may reproject the radial data to any differently defined grid (radial, equirectangular, or otherwise) for applying the same vertical composite technique, Step 2 initializes a one-dimensional floating-point array of 720 elements for storing the precise azimuthal angle values for each ray in the final composite product. 720 corresponds to the number of azimuthal rays sampled by the WSR-88D radar in lower elevation scans for each sweep since the deployment of “super-resolution” data in RPG/RDA Build 10 on May 5, 2008. Alternative embodiments of the present invention may elect to use different resolutions of radar data, such as simplifying the grid to legacy 1°×1 km resolution, yielding 360 radials, and comporting identically to the resolution of upper-level scans, thereby eschewing those steps in the following description which pertain to mapping the legacy resolution upper-level scans onto the “super-resolution” scans of lower elevation. The floating-point array established by Step 2 is hereinafter referred to as “BaseAzimuths”.

Step 3 allocates memory to store the final composite data. Being that the range of the NEXRAD data is limited to 4581 cm, and given the preferred embodiment's usage of one byte to store 256 levels of reflectivity data and at the full 0.5°×0.25 km resolution, the size of memory allocated for the composite data (hereinafter referred to as “CompositeData”) amounts to 720×1832×1=1319040 bytes.

Step 4 establishes a Boolean state variable referred to hereinafter as “BaseCompleted” and initialized to false, which documents the progression of the NEXRAD volume scan to determine flow execution in the second group of steps.

Step 5 establishes a state variable named “MaxDBzThresholdHeight” and initialized to 0, the function of which will be described in a following paragraph.

The second group of steps which comprise the present invention is executed upon receiving a new group of radials from the Level II data feed. A preferred embodiment of the present invention is directed to real-time monitoring purposes in which the live, interstitial radial segments of the in-progress NEXRAD volume scan are continuously retrieved and fed to the algorithm according to Volume Coverage Pattern (VCP) (specifically, the following correlations are proposed: every 10 seconds for VCPs 12 and 212, every 17 seconds for VCPs 21 and 212, every 27 seconds for VCPs 11, 121, 211, and 221, every 40 seconds for VCPs 31 and 32, and half the aforesaid time when the “BaseCompleted” state variable is false), however the present invention may also be implemented to different purposes (such as archived data display) in which all radials constituting the entire volume scan at all tilts are composted according to the following algorithm in a single execution.

Step 1 of the second group of steps identifies the new radials not formerly processed by the algorithm and loops through them individually. All following steps refer to the processing of each individual radial and are thus invoked many times by the loop defined in this first Step 1.

Step 2 determines whether or not the ray/radial (terms used herein synonymously) represents the start of a new radar volume (that is, the first ray in the first scan of the volume, the 0.5° base tilt scan), in which case the “BaseAzimuths” floating-point array is initialized with values deriving from the azimuthal value indicated in the NEXRAD data for this initial ray of the volume. The first array element is made exactly the azimuth value given for this first radial in the data. The subsequent array elements are progressively incremented from the value of the prior by the radial resolution in degrees, which is 0.5 in the preferred embodiment of the present invention. This step represents merely an initialization for robustness purposes as values in the same array are later redefined by the exact azimuths reported in the data headers for each radial, which are prone to minor error and which do not always strictly obey the mathematically pure angular increment resulting from the division of 360 by the number of radials in a given scan.

Step 3 examines the angular width of the present radial (that is, the azimuthal resolution of the sweep/scan (terms which are synonymous in this disclosure) from which they derive); in the NEXRAD Level II from RPG/RDA Build 10 to the present, this resolution is either 0.5° (i.e., the “super-resolution” scans of 720 radials, which comprise the lower tilt elevation scans) or 1° (i.e., legacy-resolution scans of 360 radials comprising the mid-level and highest tilt elevation scans). If the radial is of high-resolution 0.5° width, the routine progresses to Step 4. If the radial is of legacy-resolution 1° width, the routine progresses to Step 5.

Step 4 first examines the “BaseCompleted” variable; if false, the algorithm finalizes the formerly initialized “BaseAzimuths” array at the element corresponding to the current radial by setting the value to match exactly the azimuth reported in the NEXRAD data for the current radial. If “BaseCompleted” is true, then preparations are made to compost the radial according to a number of substeps:

Substep 1 determines whether or not the current radial is the first of a new scan/sweep at a given tilt elevation; this information is given in the header data for message type 31 NEXRAD data packets, which are the parts of the NEXRAD Level II data stream which contain reflectivity data and which pertain to the present invention. In particular, the “azimuth number” is given, which documents the radial's position within the current sweep from 1 to 720 (with “super-resolution” sweeps of lower tilt elevations) or from 1 to 360 (with legacy-resolution sweeps of higher tilt elevations). Therefore Substep 1 tests whether or not the current radial's “azimuth number” is equal to one. If it is not, the algorithm jumps directly to substep 4. If the current radial is however the first ray of a new sweep, the algorithm progresses to substep 2

Substep 2 resets the “MaxDBzThresholdHeight” state variable to zero if the scan elevation of the radial is less than 0.7° , which is intentionally equivalent to resetting the variable if the radial is the first in a SAILS-base sweep. “SAILS” refers to the “Supplementary Intra-volume Adaptive Low-level Scans” enhancement which recent NEXRAD software implementations have achieved at the time of this application's writing, in which additional 0.5° tilt base scans are inserted into the middle of the volume scan, thus altering the Volume Coverage Pattern (VCP) to provide more frequent coverage of the base region, and which quite benevolently serves the purpose of the present invention. Since Substep 2 is only achieved if “BaseCompleted” is true, it is certain that any radials less than 0.7° in elevation angle handled in this part are constituents of the aforesaid SAILS sweeps. It must be carefully noted that the preferred embodiment of the present invention does not re-initialize the composite at the genesis of every 0.5° scan but rather only at the first of these which defines the start of the volume scan; SAILS base sweeps however are not composted according to the fuzzy logic procedure described in following steps, but rather in a manner which completely replaces the prior contents of the composite (without, however, altering the “BaseAzimuths” floating-point array established by the first sweep in the volume scan, for simplicity and consistency purposes). The function of the “MaxDBzThresholdHeight” state variable relates to the operation performed in the following substep.

Substep 3 calls a routine hereinafter termed “RecomputeDynamicVAPPIHeight” and invoked from within other parts of the algorithm. This routine properly computes the “VAPPITopHeight” state variable depending on the “MaxDBzThresholdHeight”, the latter of which is modified in following portions of the algorithm. If “MaxDBzThresholdHeight” is less than or equal to an adaptable lower threshold (defaulted to 13,000 meters), then “VAPPITopHeight” is set to an analogous adaptable lower threshold (defaulted to 1,000 meters). If “MaxDBzThresholdHeight” is greater than or equal to an adaptable upper threshold (defaulted to 20,000 meters), then “VAPPITopHeight” is set to an analogous adaptable upper threshold (defaulted to 5,500 meters). If “MaxDBzThresholdHeight” is between the two corresponding adaptable thresholds, the value for “VAPPITopHeight” is computed by linear interpolation according to the aforesaid thresholds. The routine finally resets all “CompostFunction” instances to null for recomputation, which will be explained in a future section.

This “VAPPITopHeight” state variable, defining the “variable” height of the surface-relative reflectivity volume to which the present invention interpolates reflectivity data, imposes widespread consequences onto the functionality of the present invention. The reflectivity return echoes of all non-0.5° (non-base) tilts will be composted onto the existing composite in a future step using fuzzy logic which modulates the contribution of each return echo by a coefficient ranging from 0 to 1—a membership coefficient determined by a function of return echo height compared to the base and top VAPPI heights. Therefore, a low “VAPPITopHeight” will permit the contribution of supra-base-scan reflectivity values only at close ranges to the radar beam origin, whereas higher values of “VAPPITopHeight” will render the vertical composite more spatially expansive in terms of the region which becomes updated after the base scan by subsequent, higher scans. Desire to visualize only surface-relevant reflectivity returns constitutes the opposing tradeoff factor in favor of a lower VAPPI top. Therefore, the “RecomputeDynamicVAPPIHeight” routine represents an algorithmic approximation of an optimal value lying within the extremes of this tradeoff, and is consequently dependent upon the “MaxDBzThresholdHeight” variable by virtue of the latter's indication of the height of a maximum reflectivity isosurface (which is conducted during a subsequent portion of the algorithm). That is, the presence of strong radar echoes at higher elevations indicates that the VAPPI top may be slightly higher and still capture visualization of hydrometeoric phenomena which promote surface-relevant effects, as opposed to an utter lack of higher-level reflective atmospheric structures, indicating conversely that the VAPPI top height be more appropriately adjusted lower. From this understanding, it may be clearly deduced that the present invention is directed towards real-time visualization in severe convective storm situations, in which high-elevation convective structures are present and adopted as a proxy for ground-relative effects (most usefully, for visualizing convective storm cell motion). A subsequent and adjunct portion of one preferred embodiment of the present invention therefore describes an algorithmic process for determining whether current conditions are appropriate for employing the presently described vertical composite technique whatsoever.

Substep 4 computes the proper azimuthal offset for any high-resolution radial for which “BaseCompleted” equals true (determined in step 4), irrespective to its status as an initial or subsequent radial within the given sweep (determined in substep 1). This azimuthal offset is in reference to the construction of the primary “CompositeData” memory structure for storing the vertical composite's computed reflectivity values and makes use of the “BaseAzimuths” array to determine a floating-point “ray index” variable which transposes the current radial onto the “CompositeData” radials defined by the initial 0.5° base scan. That is, if the “CompositeData” radials were defined in the initial scan by an initial ray of azimuth 0°, and an azimuth of precisely 359.5° in the 719^{th} (and final) radial of the initial base scan, then the computation of the “ray index” variable for a radial of azimuth 0.5° degrees would be 1.0, 0.75° 1.5, 1° 2.0, etc.

The decimal element of this “ray index” is conceptually significant to the present invention. In substep 4 and in a preferred embodiment, it is rounded to the nearest integer; however, in a following section describing the handling of higher-elevation radials, it is intentionally retained instead of being discarded in an integer rounding or truncation command, since 1) as previously indicated, small amounts of azimuthal error distort each radial from the precise 0.5° or 1° azimuthal increments by which they are canonically defined, and since 2) the composting algorithm described in the third primary group of steps accounts for the disjunction of supra-base-tilt radials to the original base-tilt-defined composite rays. Justification for preferentially rounding it (the “ray index”) to the nearest integer for the high-resolution 0.5°-azimuthal-width radials to which this substep's scope of execution is limited follows from 1) low spatial error in maintaining the original radial data along the azimuthal axis given the full 0.5° resolution, compared to that of the double-width upper-level radials, 2) the desire to retain reflectivity echo maxima which may go undersampled in the non-integer azimuthal disjunct sampling correction described in a future step, and 3) computational benefits following the ability to skip the former correction and overlap the current radial exactly over a single composite radial for the composite function.

The particular manner for computing the “ray index” of the current radial in substep 4 depends on the radial's status as the first radial in an elevation scan or as a subsequent radial (determined in substep 1). If it is the first ray in the sweep, then the azimuthal offset between the first element in “BaseAzimuths” is computed and transformed into a positive angular difference between 0 and 360−∈, in which epsilon represents an infinitesimal quantity defined herein by the smallest value increment storable in whichever floating-point format being used. The “ray index” is computed from the division of the azimuthal difference by 360 and then multiplied by the number of rays in the base scan minus one, which in the preferred embodiment is 720−1=719. This floating-point “ray index” value is then preferably rounded to the nearest integer as formerly described in the prior paragraph. The exact azimuth for this initial radial is stored as “temporary variable 1” and the final “ray index” value stored as “temporary variable 2” for future executions of this substep in the subsequent radials.

When substep 4 is executed wherein the current radial is not the first in the sweep but rather a proceeding ray, then reference to “temporary variable 1” and “temporary variable 2” (having been computed and stored by the initial ray computation) is made in order to determine the value of “ray index” for the new intra-scan (or scan-ending) radial(s). Given the previously explained decision in the preferred embodiment to use round integer “ray index” values for the high-resolution post-initial-base-tilt scans in order to directly “overlay” each radial onto a corresponding base radial (as opposed to the disjunct sampling processed employed in future steps involving legacy-resolution, higher elevation scans), the precise azimuth of the current radial is discarded and redefined in accordance to the azimuth of the first radial in the sweep (stored in “temporary variable 1”). Therefore, the azimuth of the current radial becomes redefined by azimuth=“temporary variable 1”+359.5×((azimuth number−1)/719), where “azimuth number” is the radial index number identifying each radial from 1 to 720 in the present elevation scan. The computation of “ray index” accordingly equals the sum of “temporary variable 2” and “azimuth number” minus one.

Substep 5 finally sets a “no resample” flag to be referenced at a future point in the algorithm's execution during the composting process.

Step 5 prepares the current radial for the compost function in a rather similar fashion to that of step 4 substep 1, identifying whether or not the radial is the first in the sweep. If the radial is a subsequent ray of “azimuth number” greater than one, the algorithm jumps directly to substep 3. If it is however the initial ray of a given sweep, then the algorithm progresses to substep 1.

Substep 1 calls the “RecomputeDynamicVAPPIHeight” routine in a fashion analogous to step 4 substep 3.

Substep 2 computes the azimuthal offset in a manner identical to that described in the first paragraph of step 4 substep 4. The computed “ray index” for substep 2 is also in fact rounded to the nearest integer, a defense of which proceeds the immediately following methodical description. The further aspects of the currently described substep 2 thereafter differ from its analogous counterpart in step 4 since the current substep is executed for legacy-resolution radials of double-width 1° azimuth, and therefore each radial described in step 5 will hereinafter be composted twice in a future step, at two different azimuthal increments, as to simulate that the 360 radials in legacy upper-level legacy-resolution scan be bisected into two identical rays, thereby maintaining the lower-tilt “super-resolution” 0.5° azimuthal definition. To this end, and since the current ray will be extended across two azimuthal increments, a conditional check on the rounded “ray index” heretofore calculated in the currently described substep 2 is performed. If it is equal to 719 (or whatever be the maximum element index of the “BaseAzimuths” array, which is 719 in the preferred embodiment using the NEXRAD “super-resolution” data), then an additional condition is evaluated: if the absolute value of the azimuthal difference between the precise azimuth of the current radial and the first element of “BaseAzimuths” is less than the absolute value of the azimuthal difference between the precise azimuth of the current radial and the last element of “BaseAzimuths”, then the “ray index” is set to zero. If not, it is left at its existing value heretofore computed in the first part of substep 2. This is equivalent to incrementing the “ray index” from its maximum value to its minimum value (that is, from the final ray in the sweep to the adjacent initial ray) if it is closer to the latter than to the former.

If the initially computed “ray index” of radial is not equal to 719, then the following conditional check is made: if the absolute value of the azimuthal difference between the precise azimuth of the current radial and the “ray index”+1 element of “BaseAzimuths” is less than the absolute value of the azimuthal difference between the precise azimuth of the current radial and the “ray index” element of “BaseAzimuths”, then “ray index” is incremented by one. This is conceptually identical to the former conditional adjustment for radials of “ray index” 719, with the latter differing only in that it handles the discontinuity occurring between the last and first rays.

Identically to step 4 substep 4, the presently described step 5 substep 2 stores the exact azimuth for this initial radial in the sweep as “temporary variable 1” and the final “ray index” value stored as “temporary variable 2” referenced in processing the subsequent 1° azimuthal-width radials.

The choice of rounding the “ray index” herein must be defended. While alternative embodiments of the present invention may handle this fine point in diverse fashions, the preferred embodiment will round to the nearest integer “ray index” in the first radial of the given sweep in an attempt to minimize the mean azimuthal disjunction by which the present group of upper-tilt radials are superimposed onto the base-scan-defined composite data radials, thereby minimizing undersampling and permitting the proceeding composting algorithm to resample these disjunct rays by only their difference to the pattern established by the first ray of the upper-level scan. That is, the first radial of the upper-level legacy-resolution radar sweep is matched to the nearest radial in the composite data (defined, as formerly described, by the initial base sweep of the volume scan) and then the subsequent azimuths are reconstructed according to the canonical 1° interval. This massively improves what could create detrimental sampling artifacts (introducing a negative bias) during the composting process at the expense of an absolutely negligible radial error inherent to “shifting” the current scan radially by a maximum of one half-degree. Note that this differs from the treatment of low-level full-resolution 0.5° degree azimuthal-width scans in which the azimuthal resampling process does not occur whatsoever, and a directly overlapping correspondence between each radial is forced, which was priorly defended. An example which illustrates the value of the sampling technique for legacy-resolution scans follows. If each radial in such a scan were perfectly misaligned with the composite radials by 0.25° (that is, each ray halfway offset onto the next), then the azimuthal resampling process (which is specified later in the present invention's description) would decrease the membership function coefficient to 0.5 for each two composite radials onto which the hypothetically misaligned radial is being composted; this introduces “disjunct sampling” bias and artificially detracts from valid reflectivity maxima. The present method of aligning the first ray of a legacy-resolution upper-level tilt scan to the nearest corresponding composite radial largely minimizes the azimuthal misalignment between the composite radial azimuth and composted radial azimuth by which the azimuthal resampling must effectively high-pass filter valid reflectivity maxima.

Substep 3, executed for radials which succeed the initial sweep radial processed in substep 2, computes the “ray index” in a fashion identical to that described in paragraph 4 of step 4 substep 4, however without performing an integer rounding operation for the final “ray index” value. If “ray index” is greater than 719 (or whatever be the maximum radial index of “BaseAzimuths”), it is subtracted by 719 (or the same maximum radial index value) effectively to perform a wrap-around modulus of rays surpassing the last and continuing circularly onto the first. Finally, a special “extra ray” flag is set for usage in the ensuing composting process.

The third group of steps which comprise the present invention pertains to the final compositing process for each radial, and are structurally continued on a per-radial basis from the end of the prior group of steps.

Step 1 determines whether or not the current radial pertains to the initial base sweep when “BaseCompleted” equals false. If not, the algorithm proceeds directly to Step 2. If so, then the reflectivity data from the current radial is directly memory copied into “CompositeData” at the position defined by the radial's “azimuth number” with no further processing. In this case, the algorithm's execution for the given radial is complete and Step 2 is not executed; the program returns to the main loop processing each incremental ray.

Step 2 prepares the current radial for being composted according to the “CompostRay” routine. Before the “CompostRay” routine can be called, the “CompostFunction” must be determined. The “CompostFunction” variable is a pointer to a structure containing two one-dimensional floating-point arrays whose elements represent each bin in the radial (1832 in plurality, in the preferred full-resolution implementation of the present invention): the first containing beam height, and the second containing the pre-computed fuzzy logic composite membership function coefficients which modulate the contribution of reflectivity values to the composite from 1 (full contribution, at the VAPPI base height) to 0 (zero contribution, at the VAPPI top height or higher). This particular optimization step extensively boosts performance by eliminating the inefficiently redundant necessity of 1) computing the beam height at each bin in the radial, and then 2) computing the fuzzy logic composite contribution coefficient therefor, when in fact both preceding values are identical along range-analogous bins of all radials within a given sweep, given the azimuthal non-dependency of the NEXRAD beam height equation. Since intra-volume supplementary 0.5° base (SAILS) scans are preferred to replace entirely the former contents of the composite without being resampled azimuthally nor even without being interpolated to the vertical VAPPI range (in order to give the present composite radar image a basic instantiation of latest available radar return echoes at far ranges which exceed the area updatable by the composite within the VAPPI volume), therefore “CompostFunction” is set to a pointer referencing a pre-instantiated, constant compost function structure containing all 1 s in the radial-axis array of contribution coefficients (i.e., indicating full replacement) if the current radial belongs to a SAILS scan (as formerly determined in substep 2 of step 4 of the second primary group of steps which constitute the present invention). If however the current radial does not belong to a SAILS base scan, then “CompostFunction” is set to the pointer returned by the “GetCompostFunctionAtTilt” subroutine, which takes as a parameter solely the elevation/tilt angle of the current radial, and which either computes a new radial compost function or returns a pointer to an existing one of similar tilt. A description of the “GetCompostFunctionAtTilt” subroutine's operation follows in the subsequent substeps:

Substep 1 loops through the dynamic array containing heretofore computed compost functions in order to determine whether one close enough to the supplied reference tilt/elevation exists, or whether a new one must be created for the supplied reference tilt angle. The evaluated condition takes the absolute value of the difference between the tilt of each precomputed compost function and the reference tilt of the current radial being processed in step 2; in the angles are similar enough (i.e., their difference is less than or equal to a user-adaptable parameter defaulted to 0.05 and capable of being increased for performance optimization or decreased for precision optimization), then the match is made and the subroutine returns a pointer to this effectively identical compost function for the given radial tilt. If no matches are made, then the subroutine progresses to substep 2 for the construction of a new compost function.

Substep 2 creates a new element in the dynamic array of compost functions, setting an identifying tilt/elevation floating-point structure member to the supplied tilt, and filling the one-dimensional array of beam heights along the radial according to the NEXRAD beam height equation in meters:

Height(m)=1000×(SR sin(φ)+(SR̂2)/(2×1.21×6371))

In the preceding equation, Phi (φ) equals the tilt/elevation angle, and Slant Range (SR) equals the sum of the distance to the first gate (supplied in the NEXRAD Level II data) in kilometers and the one-dimensional array element index divided by four, assuming the preferred embodiment's usage of full 0.25 km radial resolution.

Substep 3 computes the fuzzy logic contribution/membership coefficients for the final composting process with reference to the corresponding beam heights and to the established vertical VAPPI extents. Each range element in the one-dimensional coefficient array is set to a linear interpolation of the beam height's position between the “VAPPIBaseHeight” (coefficient of 1.0) and the “VAPPITopHeight” (coefficient of 0.0), and then clipped to the range [0, 1] (that is, if the beam height exceeds “VAPPITopHeight”, the computed coefficient remains zero instead of linearly proceeding to a negative, non-zero value). Alternative embodiments of the present invention may implement non-linear weighting in this section in order to represent lower or higher altitude return echoes more forcefully. Substep 3 then returns a pointer to the newly created compost function.

A suitable radial compost function having been appropriated, Step 3 turns to the final prerequisite preparation step for composting the ray, that of the azimuthal resampling process. First, the integer index of the target composite radial is defined “final ray index” and set to the truncation of the previously computed, floating-point (though potentially already rounded) “ray index” variable from the second primary group of steps. As formerly discussed, the azimuths of radials from supra-base-level scans do not perfectly align with those established in the initial base scan for the composite data, and therefore an offset composted ray must be resampled to the composite ray(s) over which it is superimposed according to the amount of overlap encountered by the two radials' intersection. To this end, a floating-point variable “AzimuthalDisjunction” is instantiated and will describe the angular, azimuthal degree to which the current radial is azimuthally misaligned, or “disjunct”, from the target composite radial onto which it will be composted. If the “no resample” flag has been set earlier in the processing of the current radial (indicating that the latter belongs to a full-resolution, 0.5° beam-width scan), then “AzimuthalDisjunction” is set to one (indicating no disjunction) and no azimuthal resampling is performed. If however the “no resample” flag has not been set, computation of “AzimuthalDisjunction” follows the subsequent substeps:

Substep 1 initializes “AzimuthalDisjunction” to (0.5−X)/0.5, wherein X represents the signed azimuthal difference between the azimuth of the current radial (which may or may not accord identically to the precise azimuth of the current radial offered in the NEXRAD Level II radial message header data, given the two preceding instances in this algorithm description in which this value may be corrected to canonical azimuth increments) and the value of “BaseAzimuths” at index “final ray index”. This normalizes the offset to 1.0 for perfect alignment, 0.0 for being misaligned exactly one radial behind, and 2.0 for being misaligned exactly one radial forward.

Substep 2 is only executed if “AzimuthalDisjunction” computed in substep 1 is less than or equal to zero; otherwise, the algorithm proceeds to substep 4. Being that the current radial is identified to be at least one full radial negatively misaligned in reference to the target composite radial, the latter is decremented by one: “final ray index” is decremented. If the decrement of “final ray index” reduces it to negative one, below its lower bound, then it is set to its upper bound of 719. Then, “AzimuthalDisjunction” is recomputed in the exact manner delineated in substep 1 however using the value of “BaseAzimuths” from the newly decremented “final ray index”.

Substep 3 is only executed if “AzimuthalDisjunction” computed in substep 1 is greater than or equal to two; otherwise, the algorithm proceeds to substep 4. Being that the current radial is identified to be at least one full radial positively misaligned in reference to the target composite radial, the latter is incremented by one: “final ray index” is incremented. If the positive augment of “final ray index” increases it to 720, above its upper bound, then it is set to its lower bound of 0. Then, “AzimuthalDisjunction” is recomputed in the exact manner delineated in substep 1 however using the value of “BaseAzimuths” from the newly incremented “final ray index”.

Substep 4 tests whether “AzimuthalDisjunction” is greater than one. If so, “AzimuthalDisjunction” equals two minus “AzimuthalDisjunction”. Then, “AzimuthalDisjunction” is tested for negativity. If so, it is set to zero.

Step 4 calls the “PerformCompost” subroutine which finally applies data from the current radial into “CompositeData”. The execution flow of the “PerformCompost” subroutine follows the proceeding substeps.

Substep 1 initializes two temporary state variables “temporary variable 3” and “temporary variable 4” to zero.

Substep 2 begins a loop through all reflectivity echoes along the current radial, for which substeps 3 through 5 are executed.

Substep 3 tests whether or not the current radial contains velocity moment data. If so, an additional test at each bin (i.e., range increment) for non-null and non-range-folded reflectivity values is mandated for compositing the current bin of the current radial. If the radial contains velocity moment data and the current bin of the current radial does not contain a non-null and non-range-folded reflectivity datum, then the bin is entirely skipped and the loop proceeds to the next bin/return along the radial. It is not skipped if either the radial does not contain velocity moment data or if the current bin reflectivity datum is defined and non-range-folded.

This crucial step achieves an additional decisive benefit of the present invention over existing NEXRAD radar display systems of visualizing reflectivity data from Contiguous Doppler (CD) or Sachidananda/Zrnic (SZ-2) technique Contiguous Doppler (SZCD) scans, in which the radar beam's Pulse-Repetition Frequency (PRF) is optimized for collecting velocity and spectrum-width data moments, and therefore in which reflectivity returns are often discarded by reason of range-folding artifacts inherent to the velocity-moment-optimized PRF. However, these scans procure subjectively useful reflectivity echoes over oft expansive areas though practically in no event visualized for real-time meteorological awareness purposes. It is therefore a design purpose of the present invention to incorporate such split-cut, reflectivity-data-bearing scans as inputs to the vertical composite technique, which allow the final data product generated by the present invention to produce a truly continuous display of surface-relevant radar composite data without even the delay which velocity-specific split-cut scans would impose were they to be inviable for inclusion into the vertical composite.

Substep 3 performs the only necessary special treatment of such scans; that is, of regarding missing values not as areas lacking strong reflectivity (as is appropriate in proper, complete reflectivity scans not suffering from range-folding gaps of data) and therefore detracting from composite values, but rather ignoring such values entirely and leaving existing composite data as-is within range-folded voids. Conversely, with full reflectivity scans, zero, negative, and null reflectivity values would endeavor to decrease a greater existing composite value by whatever contribution is permitted by the multiplication of the fuzzy logic VAPPI interpolation coefficient and the azimuthal resampling coefficient. In contrast to current states of the art in which the simplistic “Composite Reflectivity” product captures multiple stages of storm cell progression into one swath of exaggerated, repetitively super-imposed reflectivity, the present invention on the other hand is capable of visually “moving forward” storm cells, bow echoes, or clusters of moving storm cells, etc., according to real-life motion, when they are at close enough ranges to the radar site such that upper level tilt scans procure meaningful near-surface reflectivity within the VAPPI volume. This tendency to depict the visual advancement of storm fronts (by means not only of composting the new, high reflectivities in areas of forward motion, but also by decreasing display reflectivities by composting lower or null values from newer scans in windward zones of a moving storm feature) represents a unique and meaningful contribution of the present invention to the current state of the art.

Substep 4 performs the actual composting operation, wherein the composite reflectivity bin at azimuth index “final ray index” and at range bin “N” equals the linear interpolation of A to B by the coefficient C (bounded to the interval [0, 1]), and wherein:

A equals the existing composite reflectivity bin value.

B equals the reflectivity value at the current bin of the currently composted radial.

C equals the product of “AzimuthalDisjunction” and of the fuzzy logic VAPPI interpolation coefficient at range bin “N” stored and previously computed within “CompostFunction”.

Substep 5 tests whether the reflectivity value at the current bin of the currently composted radial is greater than a user-adaptable reflectivity isosurface threshold, defaulted to 19 decibels. If so, “temporary variable 3” is incremented and “temporary variable 4” is set to the range bin loop index “N”.

Substep 6 occurs after the execution of the loop through each range bin and evaluates the condition of “temporary variable 3” being greater than a user-adaptable parameter defaulted to 200, and of the computed NEXRAD beam height at range bin index “temporary variable 4” (using “CompostFunction” for computational efficiency) being greater than the “MaxDBzThresholdHeight” state variable. If so, “MaxDBzThresholdHeight” is set to the beam height encountered at range bin index “temporary variable 4”. This estimates the maximum height of the particular reflectivity isosurface which is used in the “RecomputeDynamicVAPPIHeight” routine for determining an appropriate height of the VAPPI interpolation volume.

Step 5 evaluates whether the “extra ray” flag has been set; if not, the algorithm for processing the current radial is finished. If the “extra ray” flag is set (thus indicating the current radial's membership to an upper-level, legacy-resolution 1° beam-width scan), then “final ray index” is incremented. If the incremented “final ray index” exceeds the upper bound of 719, it is set to the lower bound of 0. Then, “PerformCompost” is invoked once more on the extra artificial radial which simulates that each radial of the current scan be bisected into the full half-degree radial resolution of the base composite data.

The primary vertical composite algorithm of the present invention having been fully described, several adjunct steps are proposed to the ends of implementing the primary algorithm in a functional and interactive software display environment.

In a preferred embodiment of the present invention, the total angular region of the composite updated by an execution of the algorithm above is determined and used to create a transparent white flashing update effect which indicates the spatial extent of new radials processed in the aforesaid update. Alpha-blending values are preferentially modulated along the radial axis such that a sharp dropoff to zero occurs when the VAPPI interpolation coefficients at the highest heretofore employed tilt elevation drop from 0.1 to 0.0; this achieves therefore the visual representation of updated composite reflectivity data not only along the azimuthal extent but also along the radial.

In a preferred embodiment of the present invention, the last fully complete NEXRAD volume scan is retained in memory and analyzed to determine the viability of conditions for the present invention's vertical composite technique which is suited towards mesoscale convective storm system monitoring and tracking purposes, and which does not perform well in regions of low-level stratiform precipitation lacking strong returns from upper elevations, such conditions being furthermore unlikely to trigger a WSR-88D Volume Coverage Pattern (VCP) which affords the plurality and rapid temporal succession of tilts which render the present invention useful and appropriate. Each scan from the immediately prior volume of elevation angle 3.9° or greater is iterated; the constituent reflectivity bins of the constituent radials of said scans falling below a user-adaptable threshold (defaulted to 40 decibels) are discarded. The remaining reflectivities equal to or greater than the threshold are summed together for each scan. If the summation equals or exceeds a user-adaptable threshold defaulted to 5000 decibels, then current conditions at the given radar site are deemed appropriate and sufficient for usage of the vertical composite algorithm. If no such scan in the preceding and complete NEXRAD volume satisfies the aforesaid conditional test, then current conditions are deemed inapposite to vertical composite implementation and display/execution of the latter is disabled.

The embodiments of the invention in which an exclusive property or privilege is claimed are defined as follows:

1. A technique for creating a vertical composite of NEXRAD Doppler radar reflectivity data, comprising the following steps:
ingesting radials from an incomplete NEXRAD Level II volume scan, either all at once or in progressive chunks of radials as the volume scan progresses;
vertically compositing the reflectivity values of more recent radials onto that of prior radials by means of a function which references the elevation above radar level of the aforesaid more recent radials at each range element; and
presenting the final vertical composite in memory to a graphical display.
